(19) United States
(12) Patent Application Publication
(10) Pub. No.: US 2016/0140557 A1
(43) Pub. Date: May 19, 2016

(54) E-COMMERCE BASED PAYMENT SYSTEM WITH AUTHENTICATION OF ELECTRONIC INVOICES

(71) Applicant: MasterCard International Incorporated, Purchase, NY (US)

(72) Inventors: Eduardo Puggina Hansel, Sao Paulo (BR); Ricardo Alba Alves Vianna, Sao Paulo (BR)

(21) Appl. No.: 14/789,240

(22) Filed: Jul. 1, 2015

Related U.S. Application Data
(60) Provisional application No. 62/081,830, filed on Nov. 19, 2014.

(51) Int. Cl. G06Q 20/40; G06Q 50/02; G06Q 30/06

(52) U.S. Cl. CPC G06Q 20/405; G06Q 30/0637; G06Q 50/02

(57) ABSTRACT

A payment website coordinates payment transactions related to purchases by account holders from merchants. Merchants may open transactions and request authorization from the account holders' account issuers. Upon receipt of a favorable authorization response in a particular transaction, the website may permit the merchant to append an invoice to the transaction on the website for validation by the account issuer. The account issuer may confirm that the invoice meets requirements for an applicable financing program. After validation of the invoice, the payment website may contact the account holder to obtain authentication by the account holder of the invoice and the transaction.

### CROSS-REFERENCE TO RELATED APPLICATION

This application claims the benefit of U.S. Provisional Patent Application No. 62/081,830 filed on Nov. 19, 2014, the contents of which are hereby incorporated by reference for all purposes.

### BACKGROUND

In some environments, major commercial or agricultural transactions may be financed via bank loans, sometimes supported by government-sponsored credit programs. The processes required for such transactions may be time-consuming and paper-intensive. The present inventors have recognized opportunities to leverage convenient capabilities of a payment account system to improve handling of commercial/agricultural transactions.

### BRIEF DESCRIPTION OF THE DRAWINGS

Features and advantages of some embodiments of the present disclosure, and the manner in which the same are accomplished, will become more readily apparent upon consideration of the following detailed description of the disclosure taken in conjunction with the accompanying drawings, which illustrate preferred and exemplary embodiments and which are not necessarily drawn to scale, wherein:

FIG. 1 is a block diagram/message flow diagram that illustrates a payment system provided in accordance with aspects of the present disclosure.

FIG. 2 is a diagram that illustrates functional aspects of a computer system that is part of the system of FIG. 1.

FIG. 3 is a flow chart that illustrates a process that may be performed in the system of FIG. 1 in accordance with aspects of the present disclosure.

FIG. 4 is a flow chart that illustrates another process that may be performed in the system of FIG. 1 in accordance with aspects of the present disclosure.

FIG. 5 is a block diagram representation of the computer system of FIG. 2.

### DETAILED DESCRIPTION

In general, and for the purpose of introducing concepts of embodiments of the present disclosure, a merchant may initiate a transaction via a payment website that offers e-commerce functionality. The merchant may submit the buyer's payment credentials and transaction details. The website may route a transaction authorization request to the issuer of the buyer's payment account. The issuer may provide an authorization response. The merchant may add to the transaction record further information, such as an electronic invoice and documentation of the goods that are the subject of the transaction. The account issuer may verify that the invoice and other documentation are suitable for the proposed financing of the transaction. A message may be sent from the website to the buyer/account holder with a token. The buyer may authenticate the transaction to the website using the token. The website may confirm completion of the transaction to the merchant, the buyer and the account issuer. Settlement of the transaction may occur on a short timeframe.

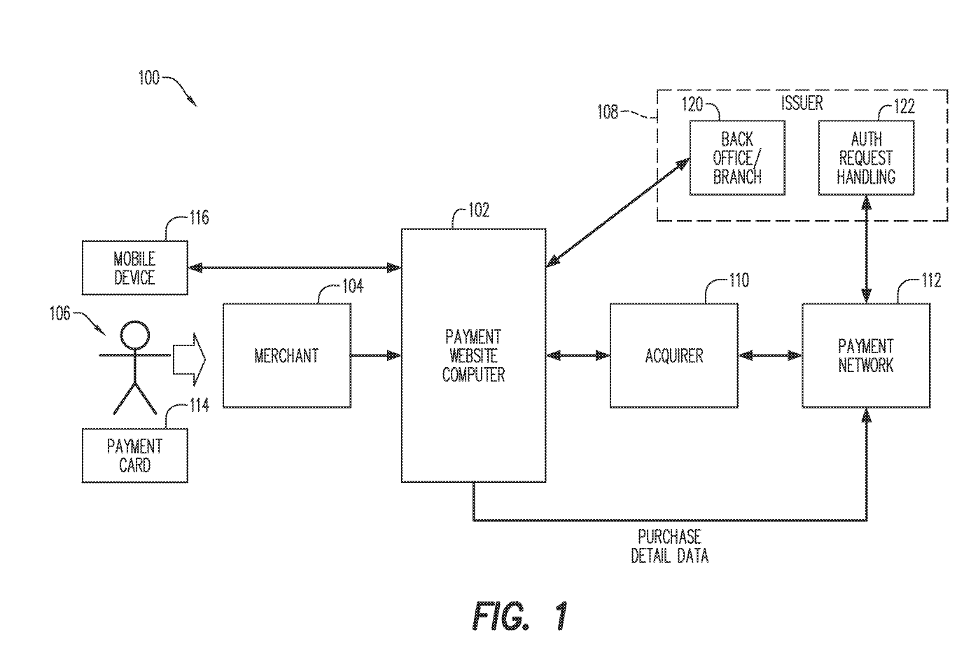

FIG. 1 is a block diagram/message flow diagram that illustrates a payment system 100 provided in accordance with aspects of the present disclosure.

A central role in the system 100 is played by a payment/e-commerce website represented by block 102 in FIG. 1. Block 102 should also be considered to represent a computer that hosts the website and performs functions related thereto, as described herein. That computer will sometimes be referred to as the “payment website computer 102.”

There are several categories of participating entities in the payment system 100. These include merchants (of which one is represented by block 104), account holders/buyers (of which one is represented at 106), payment account issuers (of which one is represented by block 108), and acquirer banks (of which one is represented by block 110). Another component of the payment system 100 is a payment network 112, which may be or may resemble the well-known Banknet payment network that is operated by MasterCard International Incorporated, which is the assignee hereof.

As indicated by block 114, the account holder 106 may have possession of a payment card, which may facilitate access to a payment account owned by the cardholder 106; it is assumed that the payment account in question was issued by the issuer 108 depicted in the drawing. Reference numeral 116 indicates a mobile smartphone, or other similar mobile device (or a conventional personal computer or the like), with which the account holder 106 may interact with the payment website computer 102 in a manner as described herein.

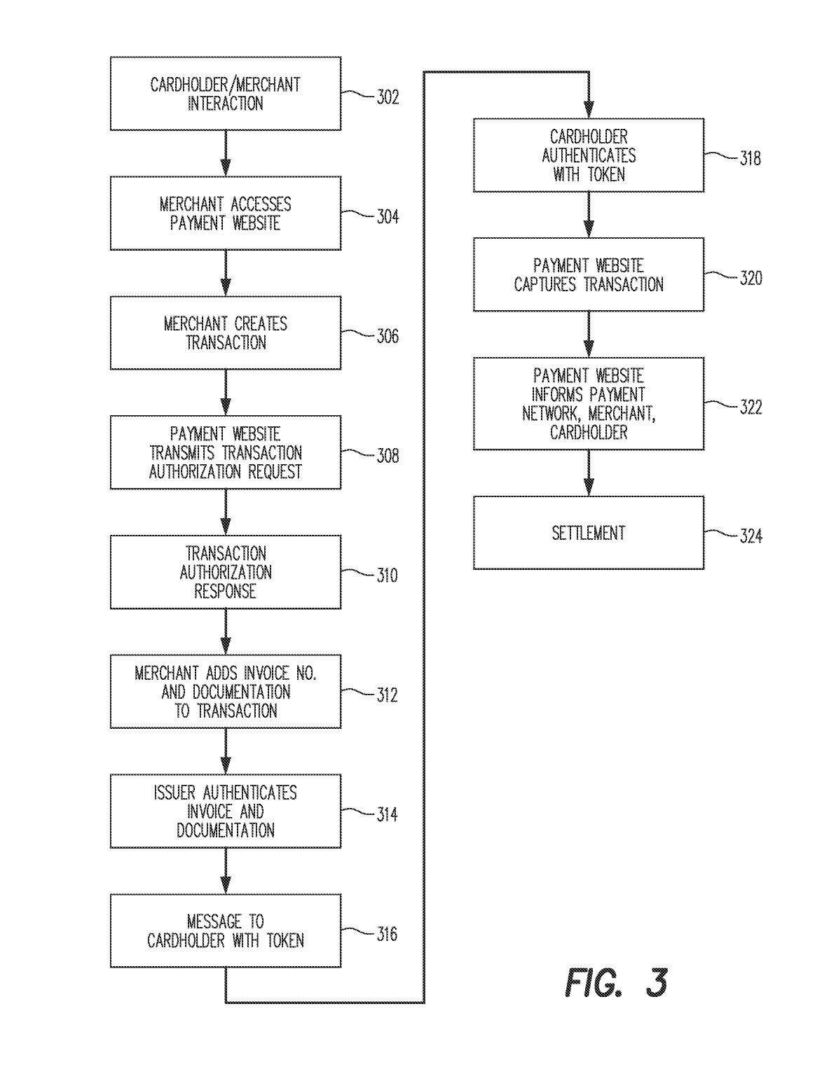

The issuer 108 is shown to include at least two constituent components, including a back-office component 120 and a payment system transaction handling component 122 (which may also be referred to as a transaction authorization request handling component). The transaction handling component 122 may be composed of or may resemble the type of functionality that receives transaction authorization requests and transmits transaction authorization responses on behalf of an account issuer in a conventional payment account system. (In some embodiments, the function ascribed to the back-office component 120 in the below description of FIG. 3 may alternatively be performed in a branch office of the issuer 108; accordingly, block 120 is alternatively labeled in FIG. 1 as a “branch” in accordance with subsequent discussion of an alternative embodiment of this disclosure.)

Each of the blocks 102, 104, 108, 110, 112, 120 and 122 should be understood to represent either or both of a respective entity and one or more computer systems operated by or on behalf of such entity.

In some embodiments, for a particular account holder, merchant, acquirer or issuer to participate in a transaction handled in the payment system 100, each such participant must previously have registered as an authorized user of the payment website computer 102 and have corresponding privileges to interact with the payment website computer 102 as described herein.

The components of the payment system 100 as depicted in FIG. 1 are only those that are needed for processing a single transaction as described herein. A typical embodiment of the payment system 100 may in practice process many such transactions (including simultaneous transactions). Moreover, a practical embodiment of the payment system 100 may include a considerable number of payment account issuers and their computers, a considerable number of acquirers and their computers, and numerous merchants and their computers. The system may also include a large number of payment account holders who use payment accounts issued by the issuers to engage in transactions as described herein.

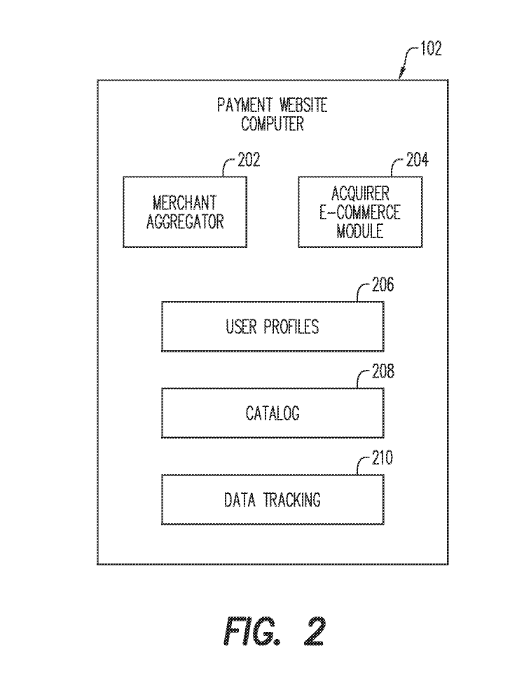

FIG. 2 is a diagram that illustrates functional aspects of the payment website computer 102. In some embodiments, the payment website computer 102 may be operated by or on behalf of an entity that also operates the payment network 112, or by or on behalf of an affiliate of such an entity.

As indicated at 202, one function of the payment website computer 102 is to serve as an intermediary between merchants (such as the merchant 104 shown in FIG. 1) and the merchants' acquirers. Thus in this respect the payment website computer 102 may play the role of a “merchant aggregator.” Correspondingly, as indicated at 204, the payment website computer 102 has an interface or website by which it interacts with acquirers, such as the acquirer 110 shown in FIG. 1.

Another function subsumed within the payment website computer 102 is—as indicated at 206—to serve as a repository of profiles of system participants (e.g., customers, merchants, acquirers, issuers) that have registered to have user accounts with the payment website computer 102.

In some embodiments, the payment website computer 102 may further facilitate commercial/agricultural transactions in accordance with aspects of the present disclosure by hosting an e-commerce catalog function, which is described further below and which is represented by block 208 in FIG. 2.

Still further, the payment website computer 102 implements transaction data tracking and reporting functionality, as indicated at block 210.

FIG. 3 is a flow chart that illustrates a process that may be performed in the payment system 100 in accordance with aspects of the present disclosure.

At 302 in FIG. 3, the account holder 106 and the merchant 104 may engage in a discussion which results in an agreement for the account holder 106 to purchase a quantity of goods from the merchant 104. The agreement may include terms such as the goods to be purchased and the purchase price. In some embodiments, the goods may be agricultural goods or other commercially-exchanged items. In some embodiments, the transaction may be of considerable monetary value, potentially hundreds of thousands of U.S. dollars or more, or a corresponding amount in a currency other than U.S. dollars.

The discussion may include the account holder 106 providing to the merchant 104 the account holder's payment credentials. In some embodiments, these may include some or all of the information typically visible on a payment account card, e.g., payment account number, expiration date, security code (e.g., “CVC”), account holder's name, etc.

In some embodiments, the account holder 106 may be located remotely from the merchant 104, and the discussion may take place via telephone or some other form of electronic telecommunication.

At 304 in FIG. 3, the merchant 104 may access/log on to the payment website computer 102.

At 306, the merchant 104 may create a transaction on the payment website computer 102. This process stage may include the merchant 104 entering information such as the transaction amount, the account holder's payment credentials, the type of financing transaction that is contemplated (e.g., the type of credit support program that is applicable to the transaction), an identification of the type of buyer under the applicable credit program, the buyer's identifier under the system registration scheme, the buyer's telephone number (e.g., mobile phone number), and a purchase transaction identifier.

At 308, the payment website computer 102 may generate a payment system transaction authorization request, which may resemble transaction authorization requests that are issued for conventional payment account system transactions. The transaction authorization request may include the transaction amount and the account holder's payment credentials. The transaction authorization request may be routed from the payment website computer 102 to the transaction processing component 122 of the issuer 108. The routing may be via the acquirer 110 and the payment network 112.

At 310, the transaction processing component 122 of the issuer 108 may transmit an authorization response. For present purposes, it is assumed that the authorization response indicates approval of the authorization request. This may be done when the issuer 108 finds that the account holder's payment account is in good standing and that the credit facility for the account holder is sufficient to support the monetary amount of the transaction. (In a possible branch of the process which is not shown, the authorization response may decline the authorization request. In such a case, the transaction may not go forward, or the merchant 104 may be required to reinitiate or amend the transaction information, etc.) In its format, the authorization response may resemble authorization responses that are provided in typical payment system transactions. However, as will be understood from further discussion, and in accordance with aspects of the present disclosure, an authorization response that approves the authorization request does not mean that the payment for the transaction has been finally approved.

The authorization response may be routed from the issuer 108 to the payment website computer 102 via the payment network 112 and the acquirer 110. In response to receiving the authorization response, the payment website computer 102 may prompt the merchant 104 (e.g., via an e-mail message) to provide further information required to validate the transaction. The merchant 104 may then access an “authorized transaction” view for the transaction, and may enter further information, as indicated by block 312 in FIG. 3. For example, the merchant 104 may update the purchase identifier with the merchant's invoice number and may upload an electronic invoice for the transaction and/or other documentation indicative of the nature and/or description of the goods that are the subject of the transaction. The updated/augmented transaction information may then be made available from the payment website computer 102 to the back-office component 120 of the issuer 108.

At block 314, the issuer back-office 120 may examine and validate the invoice and/or other documentation. This may be done, e.g., via an “issuer validation” view of the transaction as provided by the payment website computer 102. In performing the validation, the issuer back office 120 may, for example, confirm that the description of the goods is such that the transaction qualifies for the terms of the credit support program under which the purchase is to be made. If the invoice/documentation is in order, the issuer back office 120 may so indicate to the payment website computer 102. (In a possible branch of the process which is not shown, the account issuer 108 may find that the electronic invoice cannot be validated and/or that the transaction does not qualify under the terms of the applicable loan program. In such a case, the transaction may not go ahead, and the account issuer 108 may so inform the payment website computer 102.)

In response (assuming that the account issuer 108 has validated the transaction), and as represented by block 316 in FIG. 3, the payment website computer 102 may send either an SMS or similar message to the account holder's mobile device 116. The message may contain a token or code by which the account holder may indicate authentication of the transaction on the account holder's behalf.

Before doing so, the account holder may access the payment website computer 102 to view the transaction to confirm that the electronic invoice and/or other documentation of the transaction is in order.

At block 318, the account holder 106 may use the mobile device 116 to transmit the token/code received at 316 to the payment website computer 102 to indicate authentication of the transaction from the account holder's point of view. At block 320, the payment website computer 102 may then capture/finalize the record of the transaction to indicate that transaction is fully authenticated. At block 322, the payment website computer 102 may notify the merchant 104, the account holder 106 and the issuer 108 of completion of authentication of the transaction. The notification to the issuer 106 may, in some embodiments, be routed via the acquirer 110 and the payment network 112.

As indicated at block 324, settlement of the payment portion of the transaction may thereafter occur. This may take place at a standard timing that is quite prompt, e.g., the day after the notification sent at 322. As part of the settlement, in effect, the funds representing the purchase price may be transferred from the issuer 108 to the acquirer 110 for the benefit of the merchant 104.

A payment system such as that described herein may facilitate payments backed by loan programs (including, e.g., government agricultural support loans), while assuring validation of the documentation required to demonstrate that the transactions meet the conditions of the loan programs. Efficient processing may be provided by the electronic-based exchange of information. Validation by the issuer and authentication by the account holder may operate so that chargebacks of transactions may practically be eliminated.

In some embodiments, the merchant may—at block 306—manually key in the data representing the account holder's payment credentials. However, in other embodiments, or in at least some cases, a suitable reader (not shown) may read the payment credential data from the account holder's payment account card (e.g., from a chip card) or other electronic device that contains payment credential data. The reader may then supply the payment credential data automatically to the merchant for inclusion in the transaction information provided from the merchant to the payment website.

In some embodiments, the issuer back office may include individuals who inspect the electronic invoice (and/or other documents)—at block 314—via an online connection to the payment website to validate the transaction. In addition or alternatively, the issuer back office may employ machine intelligence to automatically validate the invoice and/or other transaction documents.

In some embodiments, the payment website may assign a payment system invoice number to the transaction to supplement the merchant invoice and support subsequent matching of the transaction during settlement.

In some embodiments, the payment website may host a catalog or catalogs presenting one or more products available for sale from one or more merchant participants in the system. Typically, a catalog hosted on the payment website may contain entries for numerous items available for purchase. The items offered in the catalog may have been submitted for inclusion in the catalog by a number of different merchants. In such embodiments, the buyer/account holder may assemble an order for a purchase transaction by interacting with one or more of the catalogs, in which case, the above-mentioned interactive discussion (e.g., block 302, FIG. 3) between the merchant and the account holder need not occur. The payment website may then launch the transaction based on an e-commerce order placed via the catalog or catalogs by the account holder. In some embodiments, the payment website may not include a catalog.

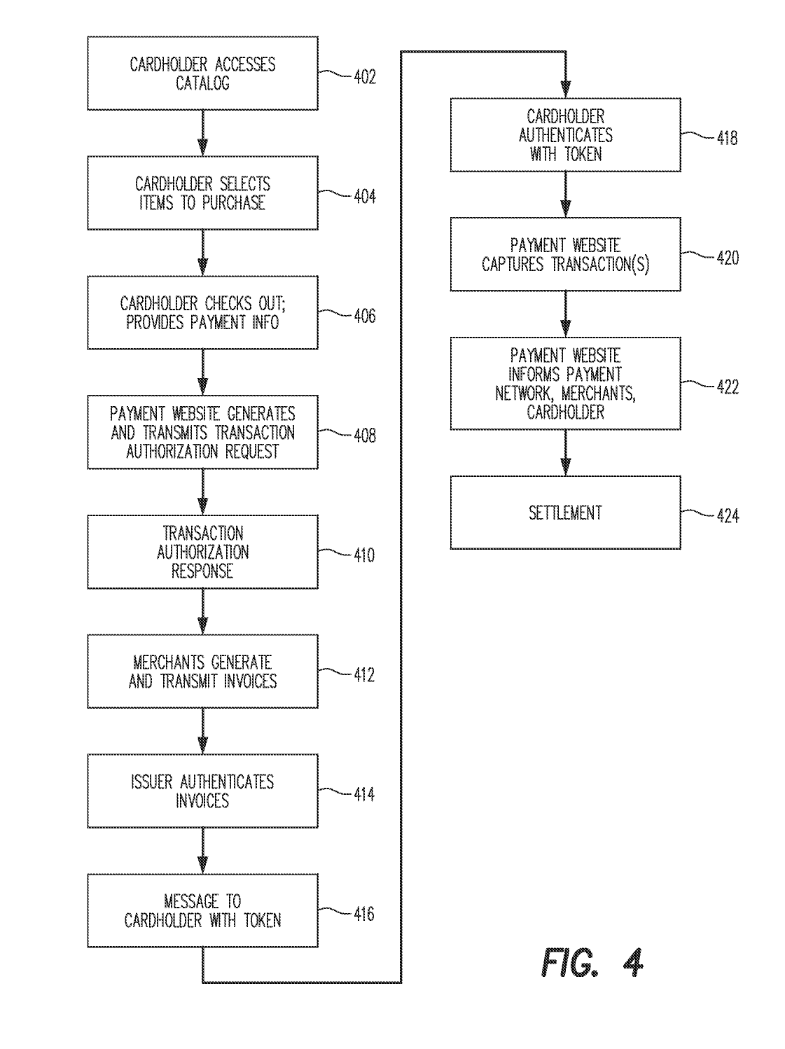

FIG. 4 is a flow chart that illustrates another process that may be performed in the payment system 100 in accordance with aspects of the present disclosure. The process illustrated in FIG. 4 is an example of a process that may occur in an embodiment in which the payment website hosts a catalog (block 208 in FIG. 2), and in particular exemplifies a transaction in which the customer/account holder 106 uses the catalog feature 208 to order/purchase one or more items offered for sale via the catalog feature 208. For purposes of the example process illustrated in FIG. 4, it is assumed that the account holder 106 selects two or more items for purchase from the catalog, and that the items selected correspond to offerings from two or more different merchants (i.e., at least one item selected is offered by one merchant, while at least one other item selected is offered by a different merchant).

At 402 in FIG. 4, the account holder 106 accesses the catalog feature 208 hosted by the payment website computer 102. At 404 in FIG. 4, the account holder 106 selects two or more items from the catalog feature 208. In some embodiments, selection of each of the items by the account holder 106 causes the item to be placed in a virtual “shopping cart,” awaiting the account holder's election of a “check out” function. As is commonly the case with an online catalog, each item may include a product description, an item number, and a price. In some cases, for a given item, there may be optional characteristics of the product that are to be specified by the customer/account holder 106. Another attribute of each item may be the identity of the merchant that is offering the product for sale via the catalog. In addition to or instead of the merchant's name, there may be an identifier code that represents the merchant in question.

At 406 in FIG. 4, the account holder 106 may elect to initiate the check-out function, and in interacting with that function, the account holder may provide his/her payment account number (or a payment account number associated with a business enterprise for which the account holder 106 is making the purchase) to the payment website computer 102.

At 408, in a process stage that may resemble stage 308 of FIG. 3, the payment website computer 102 may generate a payment system transaction authorization request. In some embodiments, where more than one merchant is represented in the catalog order, the payment website computer 102 may generate and send more than one authorization request, i.e., separate authorization requests, routed via different acquirers, with each authorization request corresponding to a respective merchant and the merchant's respective acquirer. (In other embodiments, even if different merchants with different acquirers are represented in the catalog order, the payment website computer 102 may send only a single authorization request for the entire catalog order; at a subsequent stage of the process the payment website computer 102 may present suitable settlement instructions to the issuer 108 to facilitate settlement via the various acquirers that need to be involved.)

At 410, in a process stage that may resemble stage 310 of FIG. 3, the transaction processing component 122 of the issuer 108 may transmit an authorization response or responses. As in the example process illustrated in FIG. 3, it is assumed for the purposes of the process of FIG. 4 that the authorization response(s) indicate(s) approval of the authorization request.

In response to the authorization response, and as indicated at 412, the merchants involved in the catalog order may automatically generate invoices that correspond to the items selected by the account holder 106. (This may occur, for example, in response to messages sent by the payment website computer 102 to the merchants to inform them of the order.) For example, the merchants may generate a respective invoice for each selected item and transmit them to the payment website computer 102. The payment website computer 102 may then link the invoices to the catalog order transaction and make the invoices available for review and validation by the back-office component 120 of the issuer 108.

At 414, in a process stage that may resemble stage 314 in FIG. 3, the issuer back-office component 120 may examine and validate the invoices made available by the payment website computer 102.

Assuming (as in the case of the process of FIG. 3), that the issuer validates the invoices, the process stage 416 shown in FIG. 4 may occur. Process stage 416 may resemble process stage 316 of FIG. 3, and may include the payment website computer 102 sending an SMS message or similar message to the account holder's mobile device 116. The message may contain a token or code by which the account holder may indicate authentication of the catalog order on the account holder's behalf

At block 418, which may resemble block 318 of FIG. 3, the account holder 106 may use the mobile device 116 to transmit the token code received at 416 to the payment website computer 102 to indicate authorization of the catalog order from the account holder's point of view.

At block 420, the payment website computer 102 may then capture and finalize the catalog transaction/orders. At block 422, the payment website computer 102 may notify the account holder 106, the issuer 108—and each merchant represented by an item that was selected for the catalog order by the account holder—that the authentication of the transaction was completed.

As indicated at block 424, settlement of the payment transactions related to the catalog order may thereafter occur. As in the case of the process of FIG. 3, the timing of settlement may be quite prompt. Settlement may involve transfers of funds from the issuer 108 for the benefit of each of the merchants whose products were included in the catalog order. For example, each of the merchants' acquirers may receive a funds transfer from the issuer 108 on the respective merchant's behalf

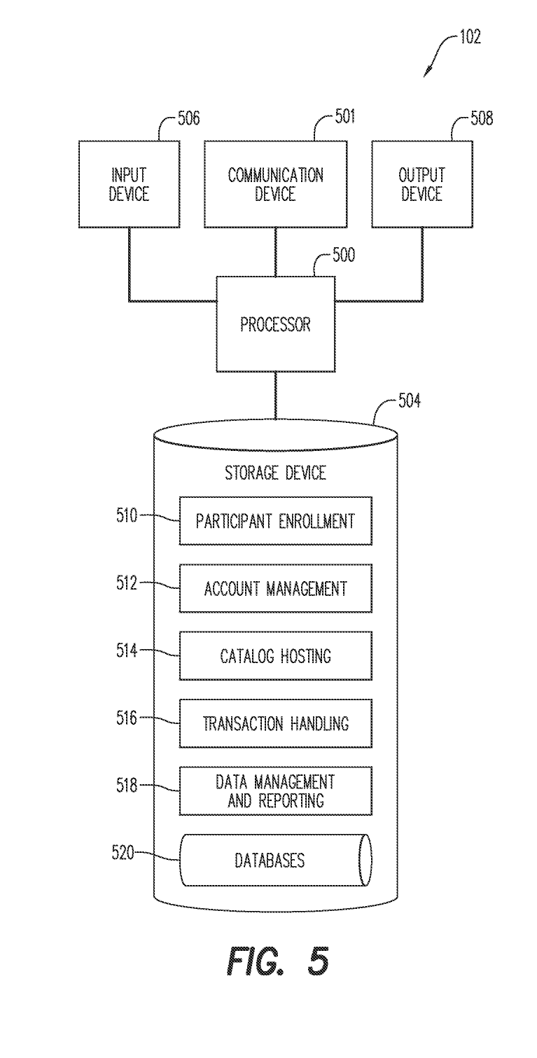

FIG. 5 is a block diagram that illustrates hardware and software aspects of an embodiment of the payment website computer 102 represented in FIGS. 1 and 2.

The payment website computer 102 may, for example, be constituted by server computer and/or mainframe computer hardware and may be controlled by software to cause it to function as described herein.

The payment network computer system 102 may include a computer processor 500 operatively coupled to a communication device 501, a storage device 504, an input device 506 and an output device 508.

The computer processor 500 may be constituted by one or more conventional processors. Processor 500 operates to execute processor-executable steps, contained in program instructions described herein, so as to control the payment website computer 102 to provide desired functionality.

Communication device 501 may be used to facilitate communication with, for example, other devices (such as computers or other devices operated by account holders, merchants, acquirers and account issuers).

Input device 506 may comprise one or more of any type of peripheral device typically used to input data into a computer. For example, the input device 506 may include a keyboard and a mouse. Output device 508 may comprise, for example, a display and/or a printer.

Storage device 504 may comprise any appropriate information storage device, including combinations of magnetic storage devices (e.g., hard disk drives), optical storage devices such as CDs and/or DVDs, and/or semiconductor memory devices such as Random Access Memory (RAM) devices and Read Only Memory (ROM) devices, as well as so-called flash memory. Any one or more of such information storage devices may be considered to be a computer-readable storage medium or a computer usable medium or a memory.

Storage device 504 stores one or more programs for controlling processor 500. The programs comprise program instructions (which may be referred to as computer readable program code means) that contain processor-executable process steps of the payment website computer 102, executed by the processor 500 to cause the payment website computer 102 to function as described herein.

The programs may include one or more conventional operating systems (not shown) that control the processor 500 so as to manage and coordinate activities and sharing of resources in the payment website computer 102, and to serve as a host for application programs that run on the payment website computer 102.

The programs stored in the storage device 504 may also include a participant enrollment application program 510 that enables the payment website computer 102 to enroll participants in the payment system, including merchants, account holders, issuers and acquirers.

In addition, the storage device 504 may store an account management program 512 that enables the payment website computer 102 to manage and maintain the user accounts of the participants in the payment system.

Moreover, the storage device 504 may store a catalog hosting program 514 that enables the payment website computer 102 to host the catalog component 208 referred to above, and to add and delete product items from the catalog, as well as handling at least a portion of catalog order transactions.

Still further, the storage device 504 may store a transaction handling application program 516 that enables the payment website computer 102 to provide transaction handling functionality such as was described above with reference to FIG. 3 and/or FIG. 4.

Also, the storage device may store a data management and reporting program 518 that enables the payment website computer 102 to store, manage and report transaction detail information on a batch basis to account issuers.

Other programs stored in the storage device 504 may include a database management program, communication software, device drivers, etc.

The storage device 504 may also store one or more databases 520 required for operation of the payment website computer 102. Such databases 520 may include, for example, a transaction database, user databases, catalog item databases, etc.

Other computers included in payment system 100 may have hardware architectures similar to that shown in FIG. 5.

In some embodiments, transaction requests may be automatically approved and/or invoices automatically validated for transactions below a threshold monetary amount. In some embodiments, the threshold monetary amount may vary depending on what type of financing is applicable to the transaction in question.

In some embodiments, validation of invoices may occur at a branch office (block 120, FIG. 1) or offices of the issuer in addition to or instead of being performed at a back office facility of the issuer. In some embodiments, invoices for some transactions may be validated at a branch office and invoices for other transactions may be validated at the back office facility.

To support invoice validation at a branch office, a branch record may be created and linked to a particular account holder record. In addition, a branch record may be created and linked to the issuer and a particular employee/system user of the issuer. An issuer user may be linked only to one branch (e.g., the branch where the user is located) and may not be permitted to view transactions related to other branches. A supervisory officer at the issuer may not be directly linked to a particular branch and may be able to view/oversee transactions at all branches of the issuer.

To further support invoice validation at branch offices, the payment website computer 102 may provide authentication data views and/or transaction list data views such that, for some users, searching within only transactions for a given branch is enabled.

When the payment website computer 102 provides e-mail notification of a transaction to the issuer, the notification in question may be sent to all issuer users linked to the branch that is the branch serving the account holder for the particular transaction.

In some embodiments, an e-commerce transaction identifier may be displayed on screen views provided by the payment website computer 102 for authorized transactions.

In some embodiments, account holders may be offered a communication channel for authenticating transactions apart from electronic mail and/or mobile telephone messaging. For example, account holders may be permitted to authenticate transactions via interaction with a call center/AVR (automatic voice response) system or an ATM (automatic teller machine). In some embodiments, or in some situations, authentication by the account holder by token or password may not be required.

In some embodiments, issuer branch offices may provide a daily report to the agricultural loan department of the issuer concerning transactions pending approval by each branch office.

As used herein and in the appended claims, the term “computer” should be understood to encompass a single computer or two or more computers in communication with each other.

As used herein and in the appended claims, the term “processor” should be understood to encompass a single processor or two or more processors in communication with each other.

As used herein and in the appended claims, the term “memory” should be understood to encompass a single memory or storage device or two or more memories or storage devices.

As used herein and in the appended claims, a “server” includes a computer device or system that responds to numerous requests for service from other devices.

The flow charts and descriptions thereof herein should not be understood to prescribe a fixed order of performing the method steps described therein. Rather the method steps may be performed in any order that is practicable, including simultaneous performance of at least some steps.

As used herein and in the appended claims, the term “payment account” includes a credit card account, a deposit account that the account holder may access using a debit card, a prepaid card account, or any other type of account from which payment transactions may be consummated. The terms “payment system account” and “payment account” are used interchangeably herein. The term “payment account number” includes a number that identifies a payment account or a number carried by a payment card, or a number that is used to route a transaction in a payment system that handles debit card and/or credit card transactions. The term “payment card” includes a credit card, debit card, prepaid card, or other type of payment instrument, whether an actual physical card or virtual.

As used herein and in the appended claims, the term “payment card system” or “payment system” refers to a system for handling purchase transactions and related transactions. An example of such a system is the one operated by MasterCard International Incorporated, the assignee of the present disclosure. In some embodiments, the term “payment card system” may be limited to systems in which member financial institutions issue payment accounts to individuals, businesses and/or other organizations.

Although the present disclosure has been described in connection with specific exemplary embodiments, it should be understood that various changes, substitutions, and alterations apparent to those skilled in the art can be made to the disclosed embodiments without departing from the spirit and scope of the disclosure as set forth in the appended claims.

What is claimed is:

1. A method comprising:
receiving first transaction data from a merchant, the first transaction data including an account holder's payment account number, the first transaction data related to a purchase transaction;
using the first transaction data to generate a transaction authorization request;
routing the transaction authorization request to an account issuer;
receiving an authorization response from the account issuer;
receiving second transaction data from the merchant, the second transaction data related to said purchase transaction, the second transaction data including an electronic invoice;
allowing the account issuer to access the electronic invoice;
receiving an indication from the account issuer that the account issuer has validated the electronic invoice;
sending a message to the account holder to indicate that the account issuer has validated the purchase transaction;
allowing the account holder to access at least some of the first and second transaction data;
receiving an indication from the account holder that the account holder authenticates the purchase transaction; and
informing the merchant, the account holder and the issuer that the purchase transaction is fully authenticated.

2. The method of claim 1, wherein the first transaction data is received via a payment website.

3. The method of claim 2, wherein the second transaction data is received via an authorized transaction view provided for said purchase transaction by said payment website.

4. The method of claim 3, wherein the account issuer is allowed to access the electronic invoice via an issuer validation view provided for said purchase transaction by said payment website.

5. The method of claim 4, wherein the account holder is allowed to access at least some of the first and second transaction data via said payment website.

6. The method of claim 5, wherein said at least some of the first and second transaction data includes the validated electronic invoice.

7. The method of claim 3, wherein the authorized transaction view includes a transaction identifier for the purchase transaction.

8. The method of claim 1, wherein the indication from the account issuer is received from a back office facility of the account issuer.

9. The method of claim 1, wherein the indication from the account issuer is received from a branch office of the account issuer.

10. The method of claim 1, wherein:
the message sent to the account holder includes an authentication token; and
the indication received from the account holder includes said authentication token.

11. A method comprising:
hosting a payment website that includes a catalog, the catalog viewable by customers and including a plurality of entries, each of said entries representing a respective product or set of products available for sale, the products or sets of products collectively offered for sale by a plurality of merchants;
receiving a plurality of indications from one of said customers, said plurality of indications including: (a) a first indication that indicates selection of a first one of said entries for purchase by said one of said customers; and (b) a second indication that indicates selection of a second one of said entries for purchase by said one of said customers; said first one of said entries representing a product offered for sale by a first one of said merchants; said second one of said entries representing a product offered for sale by a second one of said merchants;
receiving a payment account number associated with said one of said customers, said payment account number identifying a payment account issued to said one of said customers by an account issuer;
generating a transaction authorization request with respect to said products selected by said one of said customers;
routing the transaction authorization request to said account issuer;
receiving an authorization response from the account issuer;
generating electronic invoices for said products selected by said one of said customers;
receiving an indication from the account issuer that said account issuer has validated the electronic invoices; and
informing said one of the customers, the first one of the merchants and the second one of the merchants that the customer's order is approved.

12. The method of claim 11, wherein at least some of the products are agricultural products.

13. The method of claim 11, further comprising:
facilitating settlement of the customer's order such that funds are transferred from the account issuer to said first one of the merchants and said second one of the merchants.

14. A system comprising:
a processor; and
a memory in communication with the processor, the memory storing program instructions, the processor operative with the program instructions to perform functions as follows:
receiving first transaction data from a merchant, the first transaction data including an account holder's payment account number, the first transaction data related to a purchase transaction;
using the first transaction data to generate a transaction authorization request;
routing the transaction authorization request to an account issuer;
receiving an authorization response from the account issuer;
receiving second transaction data from the merchant, the second transaction data related to said purchase transaction, the second transaction data including an electronic invoice;
allowing the account issuer to access the electronic invoice;
receiving an indication from the account issuer that the account issuer has validated the electronic invoice;
sending a message to the account holder to indicate that the account issuer has validated the purchase transaction;
allowing the account holder to access at least some of the first and second transaction data;
receiving an indication from the account holder that the account holder authenticates the purchase transaction; and
informing the merchant, the account holder and the issuer that the purchase transaction is fully authenticated.

15. The system of claim 14, wherein the first transaction data is received via a payment website.

16. The system of claim 15, wherein the second transaction data is received via an authorized transaction view provided for said purchase transaction by said payment website.

17. The system of claim 16, wherein the account issuer is allowed to access the electronic invoice via an issuer validation view provided for said purchase transaction by said payment website.

18. The system of claim 17, wherein the account holder is allowed to access at least some of the first and second transaction data via said payment website.

19. The system of claim 18, wherein said at least some of the first and second transaction data includes the validated electronic invoice.

20. The system of claim 16, wherein the authorized transaction view includes a transaction identifier for the purchase transaction.
